(19) United States
(12) Patent Application Publication
(10) Pub. No.: US 2026/0261054 A1
(43) Pub. Date: Sep. 3, 2026

(54) ANTENNA SYSTEM WITH RADIATING ELEMENT FED VIA SIDE REGION

(71) Applicant: Telefonaktiebolaget LM Ericsson (publ), Stockholm (SE)

(72) Inventors: Tanja Hefele, Waakirchen (DE); Thomas Ettstaller, Bad Aibling (DE); Andela Zaric Fonseca, Munich (DE); Elcin Ergin, Rosenheim (DE); Manuel Perez, Rosenheim (DE)

(21) Appl. No.: 18/838,445

(22) PCT Filed: Feb. 15, 2022
(86) PCT No.: PCT/EP2022/053642

§ 371 Date: Aug. 14, 2024

(51) Int. Cl. H01Q 21/06; H01Q 1/24; H01Q 5/48; H01Q 19/10; H01Q 21/00

(52) U.S. Cl. CPC H01Q 21/062; H01Q 5/48; H01Q 19/108; H01Q 21/0006; H01Q 1/246

(57) ABSTRACT

An antenna system comprising a dual-polarized radiating element extending generally in a first direction parallel or substantially parallel to a reflector of the antenna system is disclosed. The antenna system further comprises a feeding structure extending generally in a second direction having a component perpendicular to the reflector and being spaced apart, in relation to the first direction, from a center portion of the radiating element. The antenna system further comprises a coupling feeding line electrically coupling the center portion of the radiating element with the feeding structure. The antenna system further comprises a dielectric substrate at least partially extending parallel to the first direction. The radiating element is at least partially arranged on a first side of the dielectric substrate. The coupling feeding line is at least partially arranged on one or both of the first and second sides of the dielectric substrate.

### TECHNICAL FIELD

This invention generally relates to an antenna system. The antenna system comprises, in particular, a coupling feeding line at least partially extending in a plane parallel to a dual-polarized radiating element of the antenna system. A feeding structure for the dual-polarized radiating element is arranged to the side of the dual-polarized radiating element and the coupling feeding line couples a center portion of the dual-polarized radiating element with the feeding structure.

### BACKGROUND

Base station antennas according to the state of the art are provided as multiband array antennas. Dual-polarized radiating elements are provided which operate in different frequency bands. The different radiating elements may hereby be arranged in a multitude of band-individual array columns. Different bands in which multiband antenna arrays according to the state of the art typically operate are low-band (600 MHz-960 MHz), mid-band (1400 MHz-2700 MHz) and high-band (3200 MHz-4200 MHz). In order to realize broadband behavior, often dipole radiators or dipole-like radiators (such as, for example, edge radiators or loop radiators) are used.

High-band and low-band radiating elements may be provided in which an interleaving design is realized with a central feeding structure of the cross-dipole low-band antenna elements. The position of the low-band antenna elements is adjusted to the position of the high-band antenna elements, such that an adjustment of the vertical concepts to each other is required.

FIGS. 1a and 1b show top views of schematic illustrations of multiband systems according to the state of the art.

In FIG. 1a, the multiband array antenna 100 comprises low-band antenna elements 102 and high-band antenna elements 104. In this example, the low-band antenna elements 102 and high-band antenna elements 104 are arranged in an interleaving manner.

In FIG. 1b, the multiband array antenna 150 also comprises low-band antenna elements 152 and high-band antenna elements 154, whereby the interleaving arrangement of the low-band and high-band antenna elements 152 and 154 is implemented by some of the high-band antenna elements 154 being surrounded by parts of low-band antenna elements 152.

Interleaving designs according to the state of the art are based on a central feeding structure for the antenna elements or a split version in which the cross-polarized low-band antenna elements and the high-band antenna elements cannot be collocated. A drawback according to the interleaving concept of the multiband systems of the state of the art is that the position of the low-band antenna elements needs to be adjusted to the underlying high-band antenna elements. It may be necessary to adjust the position of the antenna elements in order to maintain performance of the individual array.

In order to serve different frequency bands in a relation 1:2, or 1:4, or 1:6 (with respect to the different frequencies), the vertical and horizontal arrangements of the different radiators become complex. Interleaved structures are therefore often used, i.e. the high band and low band radiators are arranged interleaved in a horizontal and vertical position, as outlined above, and as shown in, for example, U.S. Pat. No. 10,177,438 B2. Another solution is shown in EP 2 710 668 B1, where a triangular low-band radiator is used to avoid overlapping of the radiators at the positions in the dual-band array.

Patch radiators are used for small height implementations with an eccentrical feeding, but known technologies are used for a single radiator antenna array.

Examples are shown, for example, in U.S. Pat. No. 6,462,710 B1, where a patch array for dual polarization is shown. This implementation operates in a single frequency band. Wideband approaches are discussed in Jin Zhang et al., “4. Wideband Dual Polarization Patch Antenna Array With Parallel Strip Line Balun Feeding”, IEEE AP Letters, Vol. 15, 2016, pp. 1499-1501, where the wideband is limited to the frequency band between 1.7 and 3 GHz. Further prior art can be found in, for example, D.A. Buhtiyarov, “1. Input Impedance of Ends-Fed Dipole Radiator with Prescribed Phase Difference Between Excitation Currents”, 2014 12TH INTERNATIONAL CONFERENCE APEIE—34006. In US 2021/0305718 A1, examples for some excentrical feeding structures are shown, whereby in this approach, the feeding structure limits the available space below the low-band radiators.

In order to keep the required isolation with respect to the different polarizations and to realize good radiation characteristics, the radiating elements may be required to be fed in the center region of the radiating elements. Therefore, the feeding balun is normally based in the center of the radiating element at or on the reflector. Alternative solution with split feeding points for the same polarization are limited to the approach that the feeding lines or balunes are realized in the plane of the reflector. Known implementations do not solve the problem for the arrangement of different radiator types for the different frequency bands, which are arranged at least partially in interleaved positions, but also have overlapping areas. In the volume over the reflector, there is a requirement for stacked positioning of the different radiators for different bands. The problem is therefore to realize a multiple band implementation using different radiating elements with a high degree of freedom for location and keep the electrical performance especially with respect to isolation, radiation characteristic and cross-polar ratio.

### SUMMARY

The inventors have realized that the feeding structure of the low-band radiating element results in performance degradation of the (underlying) high-band radiating elements and their radiation pattern. The adjustment of the position of the low-band radiating elements with respect to the position of the high-band radiating elements may also result in insufficient use of the low-band radiating element volume due to planar geometries of cross-dipole arms, thereby resulting in a limited low-band radiating element bandwidth. There is therefore a need for improved antenna systems.

According to the present disclosure, there is provided an antenna system comprising a dual-polarized radiating element extending generally in a first direction parallel or substantially parallel to a reflector of the antenna system, wherein the dual-polarized radiating element is configured to emit an electromagnetic wave. The antenna system further comprises a feeding structure extending generally in a second direction having a component perpendicular to the reflector of the antenna system. The feeding structure is spaced apart, in relation to the first direction, from a center portion of the dual-polarized radiating element. The antenna system further comprises a coupling feeding line electrically coupling the center portion of the dual-polarized radiating element with the feeding structure for feeding an electrical signal via the feeding structure through the coupling feeding line to the center portion of the dual-polarized radiating element. The antenna system further comprises a dielectric substrate at least partially extending parallel to the first direction. The dual-polarized radiating element is at least partially arranged on a first side of the dielectric substrate. The coupling feeding line is at least partially arranged on one or both of the first side and a second side of the dielectric substrate, wherein the first side faces towards a direction opposite to a direction towards which the second side faces.

The dielectric substrate may, in some examples, be part of (i.e. integrated in) a layer prepared via a sheet metal technology and/or a molded interconnect device (MID) in which an injection-molded thermoplastic part comprises integrated electronic circuit components.

In some examples, at least 70%, preferably at least 80%, more preferably at least 90% of a length of the coupling feeding line extends parallel to the first direction.

In some examples, the first side faces away from the reflector, and the second side faces towards the reflector.

In some examples, a distance, in a direction perpendicular to the reflector of the antenna system, between the coupling feeding line and a plane in which the dual-polarized radiating element extends, is smaller than a distance between the coupling feeding line and the reflector. In some examples, the distance is zero, i.e. the coupling feeding line extends (at least partially or fully) in the plane in which the dual-polarized radiating element extends.

In some examples, a distance, in a direction perpendicular to the reflector of the antenna system, between the coupling feeding line and a plane in which the dual-polarized radiating element extends, equals to or is less than 1/20 of a wavelength of the electromagnetic wave. In some examples, the distance is zero, i.e. the coupling feeding line extends (at least partially or fully) in the plane in which the dual-polarized radiating element extends.

In some examples, the second direction is perpendicular or substantially perpendicular to the reflector of the antenna system.

In some examples, the coupling feeding line extends, in the first direction, at least from an edge portion of the dielectric substrate to the center portion of the radiating element.

In some examples, the antenna system further comprises a printed-circuit board arranged on the dielectric substrate. The dual-polarized radiating element and the coupling feeding line are comprised in the printed-circuit board.

In some examples, one or more metallic parts of the dual-polarized radiating element serve as a ground for the coupling feeding line.

In some examples, an extension shape of the coupling feeding line in the first direction is at least partially (or fully) identical to an extension shape of the dual-polarized radiating element in the first direction.

In some examples, the coupling feeding line comprises two lines running generally parallel to each other. A first line of the two lines is arranged on the first side of the dielectric substrate. A second line of the two lines is arranged on the second side of the dielectric substrate. The two lines connect with each other at an end portion of the feeding structure.

In some examples, the feeding structure comprises a first feeding structure and a second feeding structure for providing electrical signals to the dual-polarized radiating element for emission of electromagnetic waves with two different polarizations. The antenna system further comprises one or more dielectric support structures coupled to the first feeding structure and the second feeding structure to support the first feeding structure and the second feeding structure. The first feeding structure and the second feeding structure are spaced apart from each other by a distance equal to or greater than 0.2 times a wavelength of the electromagnetic waves emittable by the dual-polarized radiating element.

In some examples, the antenna system further comprises a dielectric bridge support structure bridging over at least a portion of the reflector of the antenna system. The antenna system comprises two said dual-polarized radiating elements, wherein a first one of the dual-polarized radiating elements is arranged on a first end portion of the dielectric bridge support structure, and a second one of the dual-polarized radiating elements is arranged on a second end portion of the dielectric bridge support structure. The first end portion of the dielectric bridge support structure is opposite or substantially opposite to the second end portion of the dielectric bridge support structure.

In some examples, the antenna system further comprises one or more at least partially metallic elements arranged on the dielectric bridge support structure between the first dual-polarized radiating element and the second dual-polarized radiating element. The one or more at least partially metallic elements are electrically isolated from both the first dual-polarized radiating element and the second dual-polarized radiating element.

In some examples, the dual-polarized radiating element comprises a corrugated structure.

In some examples, the antenna system further comprises one or more stubs or lines arranged on the dielectric substrate. The one or more stubs or lines extend at least in the center portion of the dual-polarized radiating element.

In some examples, a width of the coupling feeding line varies along its length between a coupling of the coupling feeding line to the center portion of the dual-polarized radiating element and a coupling of the coupling feeding line to the feeding structure.

In some examples, the feeding structure is arranged at an edge portion of the dielectric substrate. The dual-polarized radiating element comprises four loops arranged, on the dielectric substrate, generally symmetrically around the center portion of the dual-polarized radiating element. A first loop and a second loop form a first dipole arm of the dual-polarized radiating element, and a third loop and a fourth loop form a second dipole arm of the dual-polarized radiating element.

In some examples, the first loop is arranged closer to the feeding structure than the second loop, and the third loop is arranged closer to the feeding structure than the fourth loop.

In some examples, the first loop is arranged on the first side of the dielectric substrate. The second loop is arranged on the second side of the dielectric substrate. The third loop is arranged on the second side of the dielectric substrate. The fourth loop is arranged on the first side of the dielectric substrate.

In some examples, the first loop and the third loop are connected to a ground, and the second loop and the fourth loop are connected to a respective coupling feeding line.

In some examples, the first loop and the second loop are electrically coupled to each other via a bridge arranged at the center portion of the dual-polarized radiating element.

In some examples, the coupling feeding line comprises a winding structure.

In some examples, the coupling feeding line comprises a loop structure.

In some examples, the antenna system further comprises one or more second dual-polarized radiating elements arranged, in relation to a direction perpendicular to the first direction, at least partially between the reflector of the antenna system and the dual-polarized radiating element. The one or more second radiating elements are configured to emit electromagnetic waves having frequencies which are higher than a frequency of the electromagnetic wave emittable by the dual-polarized radiating element.

In some examples, the feeding structure comprises a low-pass filter.

### BRIEF DESCRIPTION OF THE DRAWINGS

These and other aspects of the invention will now be further described, by way of example only, with reference to the accompanying figures, wherein like reference numerals refer to like parts, and in which:

FIG. 1 a and b show top views of schematic illustrations of antenna systems according to the state of the art;

FIG. 2 a and b show a top view and a cross-sectional side view, respectively, of a schematic illustration of an antenna system of example implementations according to the present disclosure;

FIG. 3 a to c show different views of schematic illustrations of an antenna system of example implementations according to the present disclosure;

FIG. 4 a to e show different views of schematic illustrations of an antenna system of example implementations according to the present disclosure;

FIG. 5 shows a schematic illustration of an antenna system of example implementations according to the present disclosure;

FIG. 6 shows a top view of a schematic illustration of a dual-polarized radiating element of example implementations according to the present disclosure; and

FIG. 7 shows a top view of a schematic illustration of a dual-polarized radiating element of example implementations according to the present disclosure.

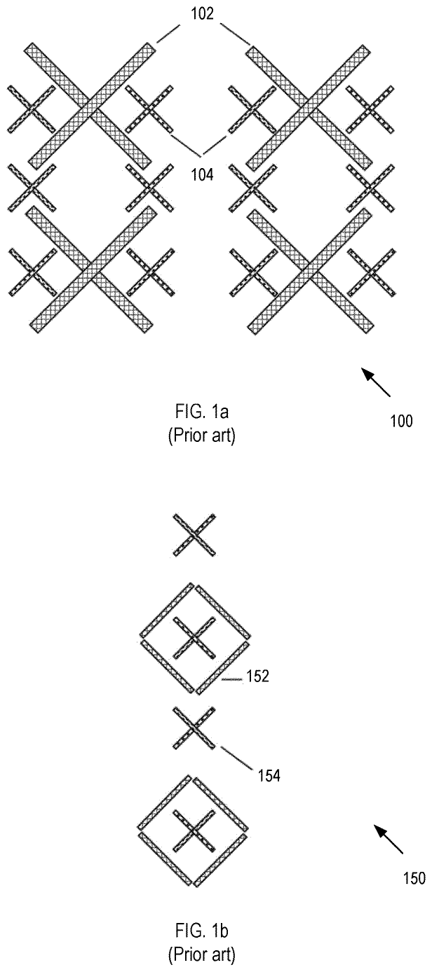

### DETAILED DESCRIPTION

The present disclosure generally relates to an antenna with a feeding of a radiating element from a side region (whereby the radiating element is fed at a feeding point at the center or center region of the radiating element). Different structures of dipole antennas may be used in combination with the feeding network. Examples of the present disclosure may in particular be implemented in base station array antenna radiator elements.

According to example implementations of the present disclosure, in particular a wideband dual-polarized cross-dipole radiating element may be fed from a side region via a feeding line coupled to a center portion of the dual-polarized cross-dipole radiating element, which exhibits good performance for low-band and good suppression of high-band scattering in particular in multiband antenna arrays.

Throughout the present disclosure, low-band may refer to (but may not be limited to) frequencies in the range of 600 MHz-960 MHz, and high-band may refer to (but may not be limited to) frequencies in the range of 1700 MHz-4200 MHz.

Some example implementations according to the present disclosure use dual-polarized radiating elements (radiators) for low-band operation and dual-polarized radiating elements (radiators) for high-band operation, which are fed by separate feeding networks. The low-band radiating elements consist, in some examples, of dipole arms, whereas the feeding points are located at the side region of the radiator arms. The feeding of the dipole arms are arranged via additional coupling lines, which form respective parts of the radiator arms.

Some of the example implementations outlined herein make use of a dual-polarized dipole radiating element for low-band operation, whereby the dual-polarized dipole radiating element may be located about a quarter of a wavelength (of an electromagnetic waves emittable by the dual-polarized dipole radiating element) over the reflector. Additional radiating elements for higher frequency operation can be arranged below this (low-band) radiating element, whereby the feeding balun or a feeding line of the low-band radiating element is arranged at the side of/from the low-band radiating element. The feeding line/balun may be connected to a central feeding point in the center or center region of the (e.g. four) radiator arms via a particular part of the feeding structure-called coupling feeding line-which may, in some examples, be formed as an integral part of the low-band radiator, arranged in the inner area of the radiator arms and forming a stripline or triplate (sandwich structure with a coupling line arranged between electromagnetic shields) line. In some examples, this triplate or micro-stripline directly uses a part of the radiator structure as a ground or the second conductor metal part of the line. In some examples, the radiator together with the coupling line comprises a PCB.

The mechanical fixation of the radiating element may be arranged at the side from the reflector, therefore fixing the radiator PCB and the balun. The balun may consist of one or two PCBs arranged on the same fixation. Alternatively, the balun contains one or more low-pass filters to prevent resonances in the higher operating bands.

The feeding of the center region of the radiating element from a region which comprises an end portion of the dual-polarized radiating element (whereby the feeding point is still in the center or center portion of the radiating element based on the coupling feeding line and the dipole arms of the radiating element being arranged on opposite sides of a substrate) enables in particular independence of an integrated advanced antenna system time division duplex system and higher flexibility for integrated antenna solutions. There are in particular no mechanical influences on the high-band antenna element modules.

In example implementations according to the present disclosure, the low-band antenna element volume is optimally utilized, resulting in improvement of the low-band antenna element bandwidth, while still being transparent to high-band antenna elements if present or not (for a modular range of use).

According to example implementations of the present disclosure, it is possible to implement additional antennas between the low-band radiating element and the reflector of the antenna system without a mechanical conflict with a feeding device positioned at the center of the (patch) antenna.

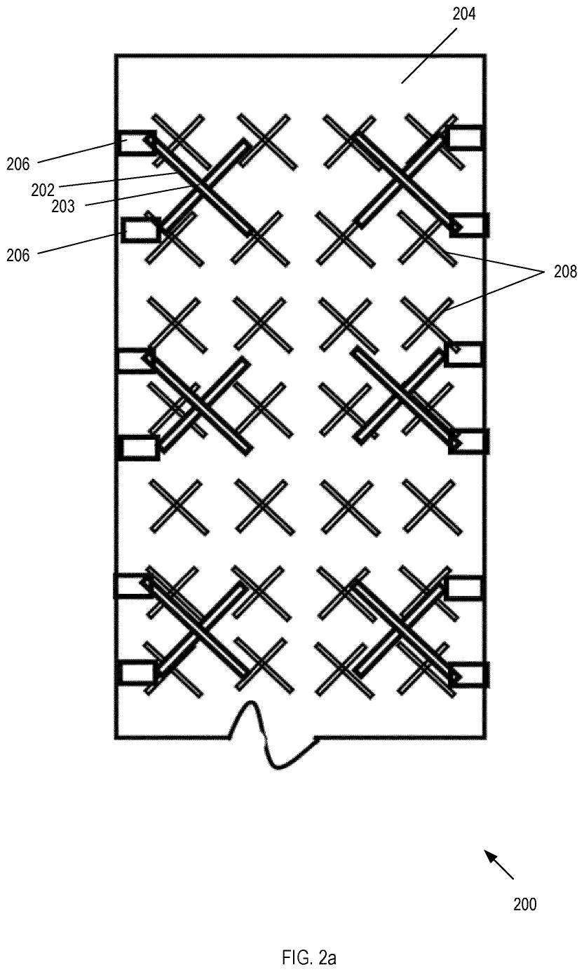

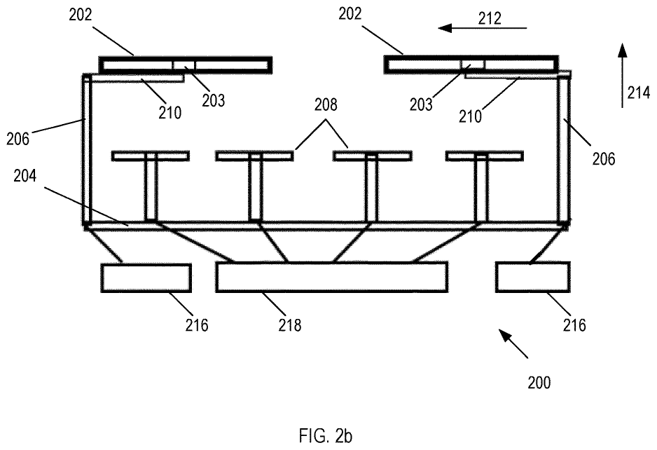

FIG. 2a and b show a top view and a cross-sectional side view, respectively, of a schematic illustration of an antenna system 200 of example implementations according to the present disclosure.

In this example, dual-polarized radiating elements 202, which are fed at the center portion 203, are arranged on the reflector 204. The feeding structure 206 for each arm of the dual-polarized radiating elements 202 are arranged, in this example, on a side region of the reflector 204. The second radiating elements 208 (which are, in this example, also dual-polarized cross-dipole radiating elements) are arranged on the reflector 204. In interleaving pattern of the arrangement of the second radiating elements 208 with respect to the dual-polarized radiating elements 202 is not required.

The feeding networks 216, 218 may consist of different parts, such as cable harness and/or PCB and are separated with respect to the two different polarizations. Furthermore, phase shifters can be included.

The (low-band) radiating elements 202 are, in this example, fed and mechanically supported by side arms, which contain the respective balun and/or a low-pass filter which can be combined with the balun. The (high-band) radiating elements 208 are arranged below the (low-band) radiating elements 202.

As can be seen in the cross-sectional side view of FIG. 2b, the coupling feeding line 210 which couples the feeding structure 206 to the center portion 203 of the respective radiating element 202 extends generally in the first direction 212. The feeding structure 206 generally extends in the second direction 214, which may be perpendicular or substantially perpendicular to the first direction 212. The first direction 212 may be parallel or substantially parallel to the reflector 204 of the antenna system 200. The second direction 214 may be perpendicular or substantially perpendicular to the reflector 204 of the antenna system 200.

In this example, a feeding network 216 is provided for feeding the respective radiating element 202. Furthermore, in this example, a feeding network 218 is provided in order to feed the radiating elements 208.

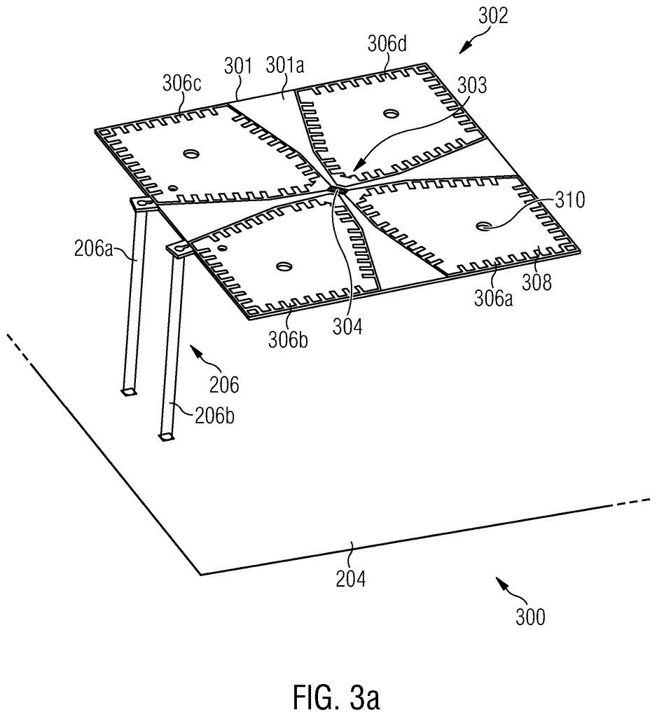

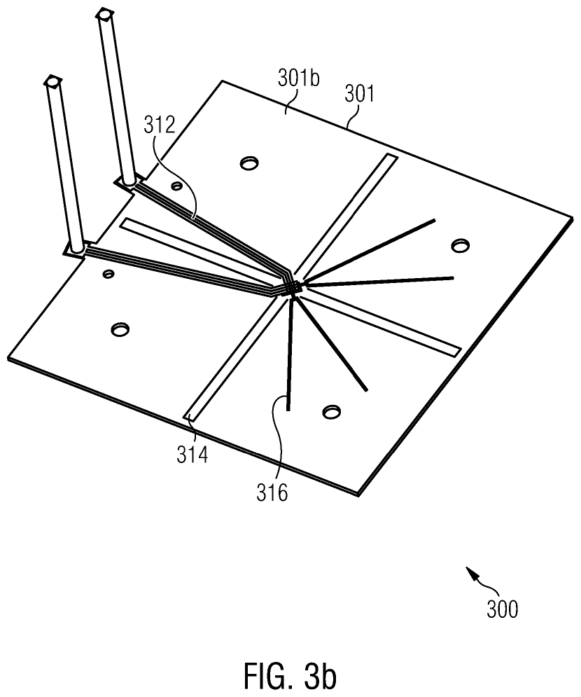

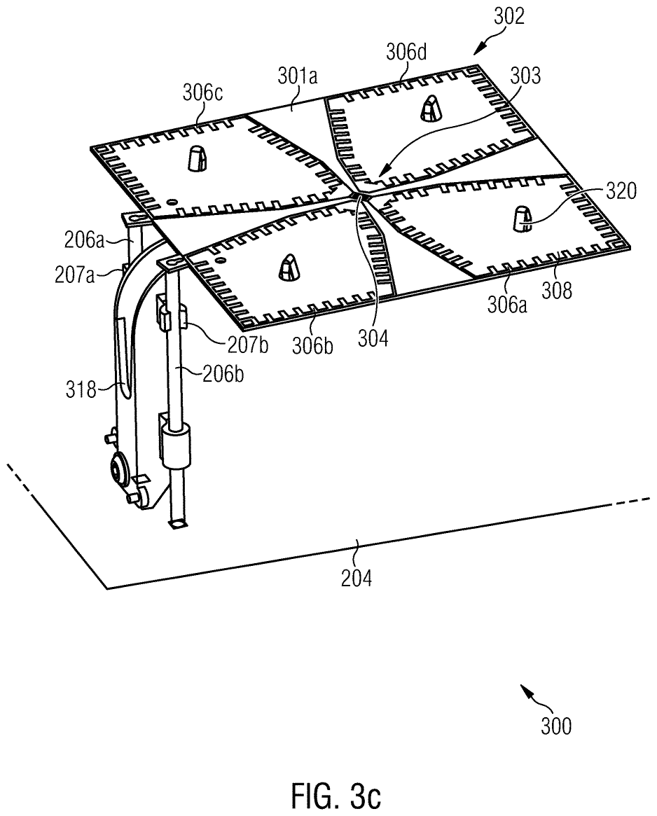

FIG. 3a to c show different views of schematic illustrations of an antenna system 300 of example implementations according to the present disclosure.

As can be seen in the perspective view of FIG. 3a, in this example, the antenna system 300 comprises a dielectric substrate 301 and a dual-polarized radiating element 302 which is arranged on a first side 301a of the dielectric substrate 301. The dual-polarized radiating element 302 is fed at the center portion 303.

A bridge 304 is provided on the dielectric substrate 301 in order to electrically couple a loop 306a with another loop 306c of the dual-polarized radiating element 302. The loop 306b is electrically coupled to the loop 306d, in this example, via a stripline.

In this example, the loops comprise a corrugated structure 308, which allows the dual-polarized radiating element 302 to be transparent for higher frequencies (stemming, for example, from high-band radiating elements arranged between the dual-polarized radiating element 302 and the reflector 204).

In this example, the dielectric substrate 301 comprises through holes 310, through which, for example, fixation pins may be provided to support the dual-polarized radiating element 302 on a support structure.

The feeding structure 206 comprises, in this example, a first feeding structure 206a and a second feeding structure 206b, for feeding electrical signals with different (for example orthogonal) polarizations to the respective dipole arms. A first dipole arm may hereby be formed by the loops 306a and 306c, and a second dipole arm may be formed by the loops 306b and 306d. In this example, the loops are fed via a coaxial cable feed, and respective coupling feeding lines from the feeding port outside the center portion to the central feeding port are suspended striplines.

FIG. 3b shows a bottom perspective view of the schematic illustration of the antenna system 300. As can be seen, in this example, the coupling feeding lines 312 are arranged on the second side 301b (bottom side) of the dielectric substrate 301.

Furthermore, in this example, lines (or stubs) 314 are arranged on the second side 301b of the dielectric substrate 301 which allow symmetrizing the dual-polarized radiating element 302. The lines (or stubs) 314 are, in this example, connected at both ends with vias to the loops, whereby one line (stub) is connected to two adjacent loops. The impact on the side-feeding to the dual-polarized radiating element 302 may thereby be reduced.

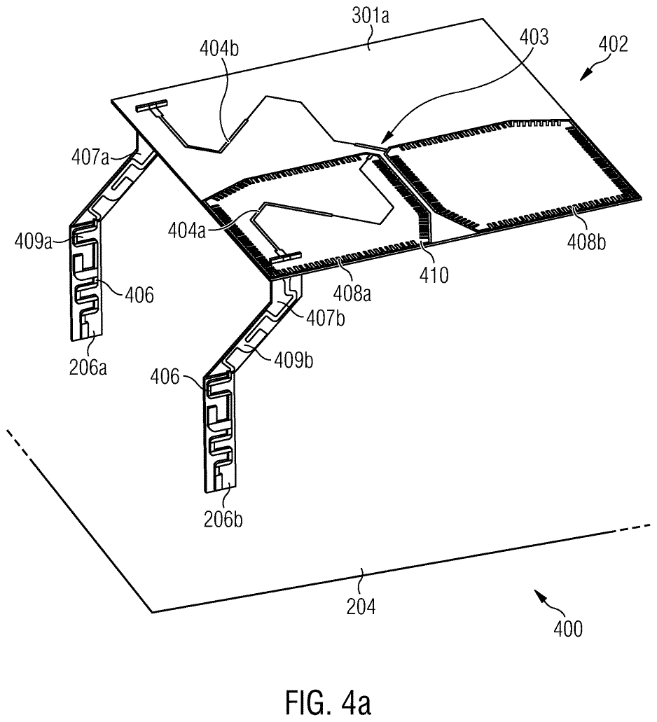

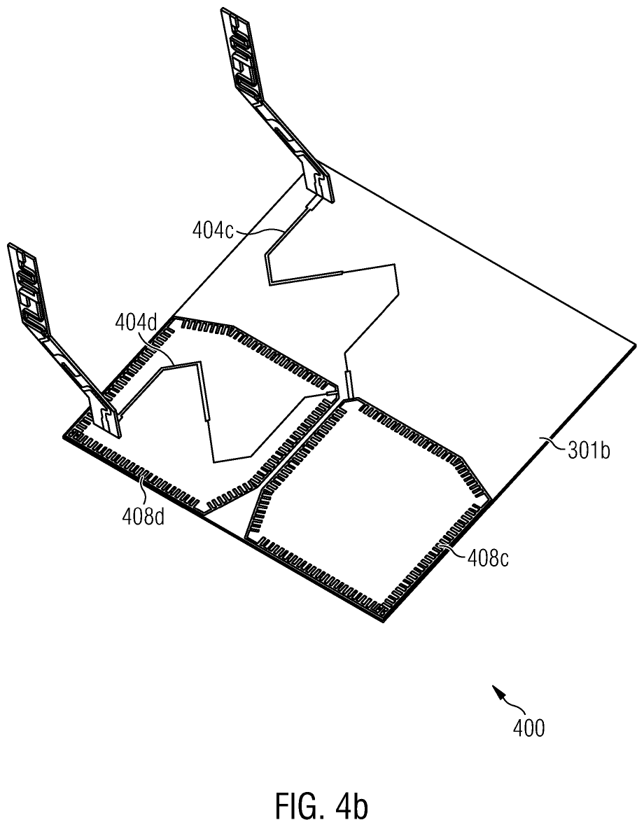

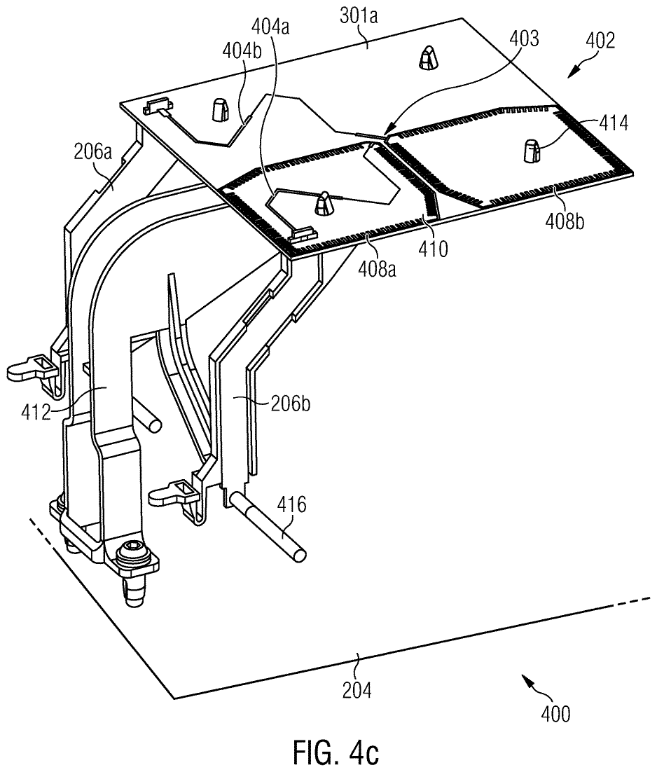

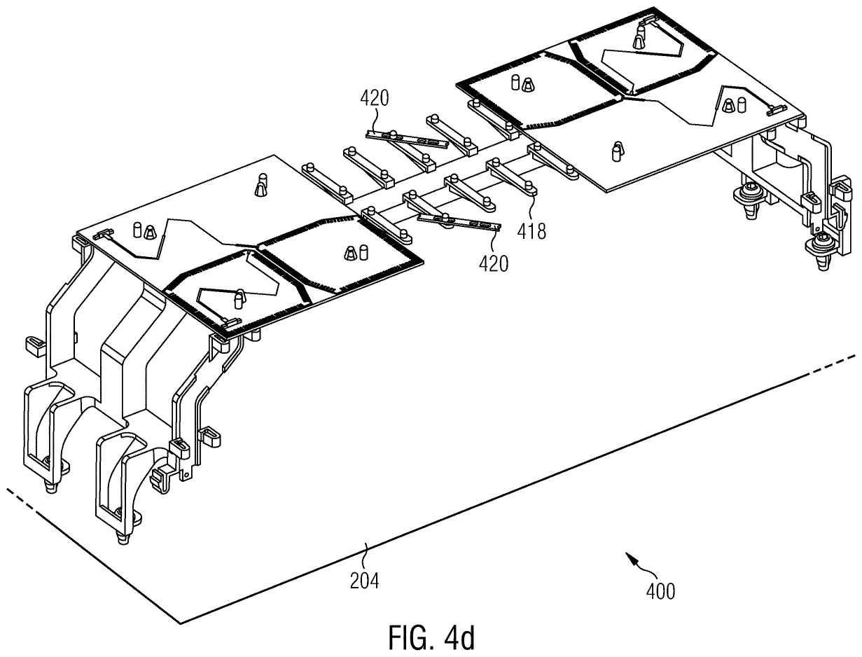

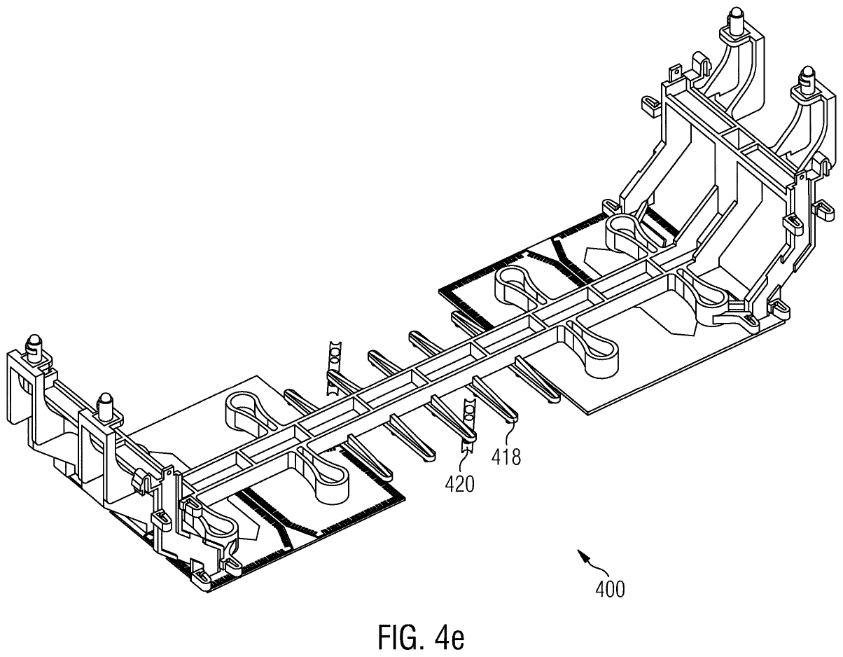

In this example, of the two loops which form a dipole arm, one is connected to ground and the other one is connected to the feeding signal. These connections may, in some examples, be direct connections (as is shown, for example, further below in relation to FIG. 4c). Alternatively, as is the case in this example, open stubs 316 are arranged on the second side 301b of the dielectric substrate 301 to realize the feeding of the dipole loops and adjust the symmetry of the radiation pattern and the impedance at the feeding point. The different coupling mechanism (galvanical connection and/or capacitively coupling via the stubs) will influence the return loss, the isolation and the pattern performance.

In this example, the loops 306a-d may be made of (thin) lines having a width of, for example, less than 0.5 cm or less than 0.1 cm, which may improve low-band performance of the dual-polarized radiating element 302 (based on tweaking the input impedance) and allow the dual-polarized radiating element 302 to be more transparent to electromagnetic waves stemming from the high-band radiating elements (not shown in FIGS. 3a-c) arranged underneath the dual-polarized radiating element 302.

In this example, a loop 306a-d may serve as a ground for the respective coupling feeding line 312.

As shown in the perspective view of the schematic illustration of the antenna system 300 of FIG. 3c, the antenna system 300 further comprises, in this example, dielectric support structures 207a-b to support the respective feeding structures 206a-b. Furthermore, a support frame 318 is provided on which the dielectric substrate 301 may be arranged. Fixation pins 320 may be used in order to mount the dielectric substrate 301 on the support frame 318.

In some examples, the coupling feeding lines 312 run, in this example, from an outer region of the substrate to the center portion 303 of the dual-polarized radiating element 302 parallel to one part of a respective loop 306b/c.

FIG. 4a to e show different views of schematic illustrations of an antenna system 400 of example implementations according to the present disclosure.

In this example, the antenna system 400 comprises a dual-polarized radiating element 402 which is fed at the center portion 403. A coupling feeding line 404a is used in order to feed a first loop 408a of the dual-polarized radiating element 402. A coupling feeding line 404b is used in order to feed a fourth loop 408b of the dual-polarized radiating element 402. As can be seen in the bottom perspective view of FIG. 4b, a coupling feeding line 404c is used in order to feed a second loop 408c of the dual-polarized radiating element 402, and a coupling feeding line 404d is used in order to feed a third loop 408d of the dual-polarized radiating element 402.

In this example, the coupling feeding lines 404c and 404d and the second loop 408c and the third loop 408d are arranged on the bottom side of the substrate, and the coupling feeding lines 404a and 404b and the first loop 408a and the fourth loop 408b are arranged on the top side of the substrate. As will be appreciated, other arrangements are possible. By providing the arrangement as shown in FIG. 4a and b, no bridge at the center portion 403 of the dual-polarized radiating element 402 is required in order to electrically couple some of the loops with each other. Furthermore, no vias (through holes) are required to make a crossing of the coupling feeding lines. In other words, a throughplating may be avoided based on the loops being arranged on different sides of the substrate (on which a printed circuit board may be arranged).

In some examples, an air bridge may be provided in order to couple loops to each other.

In this example, the coupling feeding lines comprise a winding structure, such that a higher transparency (in particular for high-band radiation from the lower-lying radiating elements) is achieved. Transmission lines being arranged on opposite sides of the substrate may hereby (generally) run in parallel for increased transparency.

In this example, for impedance transformation purposes, the coupling feeding lines have a width which various from the coupling of the respective coupling feeding line to the feeding structure to the center portion 403 of the dual-polarized radiating element 402.

In this example, the loops comprise a corrugated structure 410, which allows the dual-polarized radiating element 402 to be transparent for higher frequencies (stemming, for example, from high-band radiating elements arranged between the dual-polarized radiating element 402 and the reflector 204).

In this example, the antenna system 400 comprises dielectric support structures 407a and 407b on which respective feeding structures 206a and 206b with respective printed circuit board feeds 409a and 409b are arranged. Furthermore, in this example, a low-pass filter 406 is provided in the respective feeding structures 206a and 206b for decreasing influence on/from electromagnetic waves stemming from high-band radiating elements arranged between the dual-polarized radiating element 402 and the reflector 204.

In this example, the coupling feeding lines are provided as (suspended) striplines on the substrate.

In some examples, as can be seen in FIG. 4c, a support frame 412 with fixation pins 416 are provided. The support frame 412 is mounted on the reflector 204. The substrate is held in place on the support frame 412 and fixed via the fixation pins 416.

In this example, a feeding cable 416 is provided per polarization for feeding the respective loops of the dual-polarized radiating element 402.

The feeding structures 206a and 206b comprise, in this example, snapping fixation means to which a printed circuit board may be coupled, thereby allowing for a more stable construction of the radiating element/substrate.

As is shown in the perspective view of FIG. 4d, two of the structures shown in FIG. 4c may be combined and coupled to each other via a dielectric bridge support structure 418. In this example, at least partially (or completely) metallic elements 420 are provided as decoupling elements on the dielectric bridge support structure 418 in order to isolate the two dual-polarized radiating elements from each other. In some examples, a further dielectric substrate may be arranged between the two dual-polarized radiating elements on the dielectric bridge support structure 418, whereby the at least partially (or completely) metallic elements 420 may be arranged on the further dielectric substrate.

An example of how the dielectric bridge support structure 418 may look like is shown in the bottom perspective view of FIG. 4e.

The feeding structures 206a and 206b may be provided, in some examples, as a cable, a micro-stripline or a coaxial cable.

As can be seen in FIGS. 4a and 4b, in this example, the radiator feeding is realized with a double-sided parallel stripline on the first feeding structure 206a and the second feeding structure 206b, respectively. In some examples, one of the two strips is connected to the ground at the fixing point or transition point at the reflector and the other strip is connected to the feeding line of the feeding network 216 of the antenna. This feeding network can, for example, comprise coaxial cables and/or a microstrip feeding network PCB. For better electrical performance of the dipole, an additional balun at the feeding network 216 may be included to feed both strips of the stripline symmetrically, therefore both strips are, in such examples, connected to the feeding network.

In some examples, referring to the FIGS. 4a and 4b, a more symmetrical radiation behavior may be achieved for both polarizations if the first loop 408a and the third loop 408d are coupled to a ground while the second loop 408c and the fourth loop 408b are coupled to a respective coupling feeding line, or if the first loop 408a and the third loop 408d are coupled to a respective coupling feeding line while the second loop 408c and the fourth loop 408b are coupled to a ground. Preferred radiation pattern characteristics (i.e. more symmetrical radiation patterns) have been observed if the first loop 408a and the third loop 408d are coupled to a ground while the second loop 408c and the fourth loop 408b are coupled to a respective coupling feeding line.

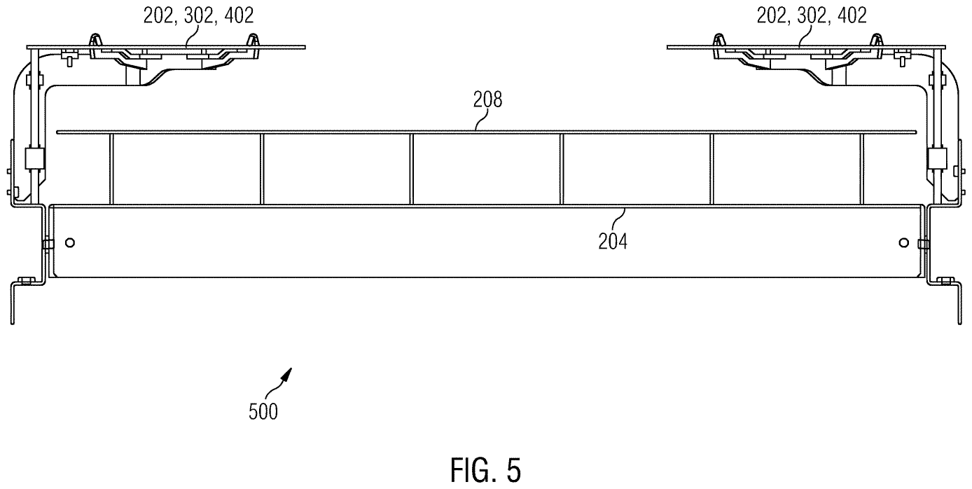

FIG. 5 shows a schematic illustration of an antenna system 500 of example implementations according to the present disclosure.

In this example, a dual-band antenna array is provided, in which the upper radiating elements, which may be one or more of radiating elements 202, 302, and 402, radiate at a lower frequency than the radiating elements 208 arranged between the upper radiating elements and the reflector 204.

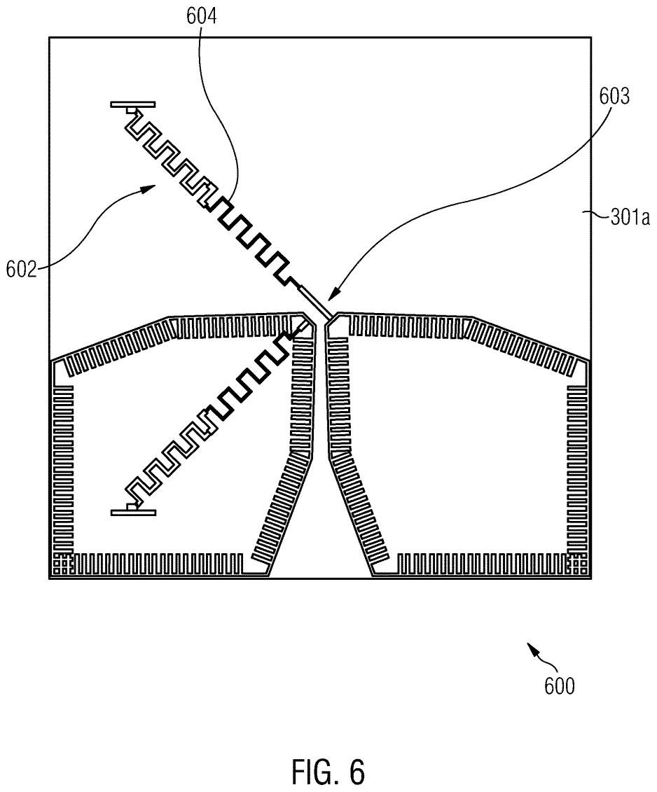

FIG. 6 shows a top view of a schematic illustration of a dual-polarized radiating element 600 of example implementations according to the present disclosure.

In this example, the coupling feeding line 602 couples the feeding structure (not shown) to the center portion 603 of the dual-polarized radiating element 600.

The coupling feeding lines 602 comprise a winding structure 604, which allows for increasing a length of the coupling feeding line 602 for impedance transformation (for example to reach a resistance of (approximately) 50 Ohms). In this example, for impedance transformation purposes, the coupling feeding lines 602 have a width which various from the coupling of the respective coupling feeding line to the feeding structure to the center portion 603 of the dual-polarized radiating element 600.

The metallic components of the dual-polarized radiating element 600 may be arranged on the top and/or bottom side of the dielectric substrate.

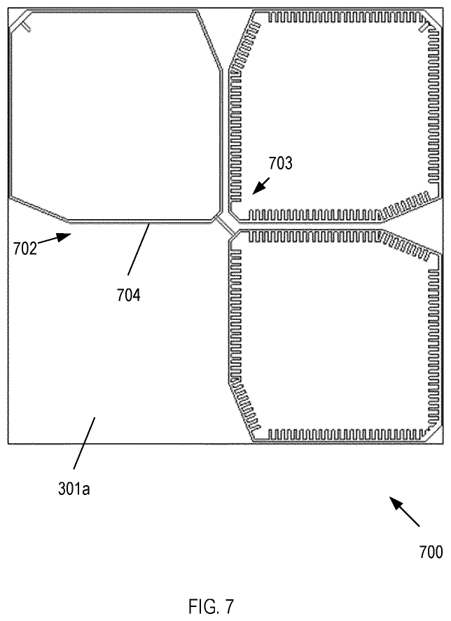

FIG. 7 shows a top view of a schematic illustration of a dual-polarized radiating element 700 of example implementations according to the present disclosure.

The coupling feeding line(s) 702 comprises a loop structure 704 which couples the metallic components of the radiating element at the center portion 703 to the feeding structure (not shown). The loop structure 704 allows for the coupling feeding line 702 to transparent for high-band radiating elements which may be arranged underneath the dual-polarized radiating element 700.

Instead of providing a complete loop for the coupling feeding line 702, a half loop may alternatively be provided.

The metallic components of the dual-polarized radiating element 700 may be arranged on the top and/or bottom side of the dielectric substrate.

Example implementations as described herein enable a high degree of freedom for the arrangement of low-band and high-band radiators, without the need of exactly interleaved arrangements. The proposed mechanical fixing (e.g. clamp) offers the combined fixing of the radiator, the feeding balun and the low-pass filters, also with the possibility to add additional elements for improving and adjusting isolation and/or radiation parameters. In some examples, the coupling feeding line is an integral part of the radiator itself, thereby not disturbing the radiation characteristics. The feeding from the side leaves a free space below the radiator for the high-band radiators. The radiator has, in some examples, a transparent design for the high-band radiators, which can be achieved by, for example, corrugated structures and/or with special filtering parts at the dipole arms. In order to prevent resonances, the part of the coupling feeding lines at the end of the radiator arms may also comprise low-pass filter arrangements.

No doubt many other effective alternatives will occur to the skilled person. It will be understood that the invention is not limited to the described embodiments and encompasses modifications apparent to those skilled in the art and lying within the scope of the claims append portioned hereto.

1. An antenna system comprising:
a dual-polarized radiating element extending generally in a first direction parallel or substantially parallel to a reflector of the antenna system, wherein the dual-polarized radiating element is configured to emit an electromagnetic wave;
a feeding structure extending generally in a second direction having a component perpendicular to the reflector of the antenna system, wherein the feeding structure is spaced apart, in relation to the first direction, from a center portion of the dual-polarized radiating element;
a coupling feeding line electrically coupling the center portion of the dual-polarized radiating element with the feeding structure for feeding an electrical signal via the feeding structure through the coupling feeding line to the center portion of the dual-polarized radiating element; and
a dielectric substrate at least partially extending parallel to the first direction,
wherein the dual-polarized radiating element is at least partially arranged on a first side of the dielectric substrate,
wherein the coupling feeding line is at least partially arranged on one or both of the first side and a second side of the dielectric substrate, wherein the first side faces towards a direction opposite to a direction towards which the second side faces.

2. An antenna system as claimed in claim 1, wherein at least 70%, preferably at least 80%, more preferably at least 90% of a length of the coupling feeding line extends parallel to the first direction.

3. (canceled)

4. An antenna system as claimed in claim 1, wherein a distance, in a direction perpendicular to the reflector of the antenna system, between the coupling feeding line and a plane in which the dual-polarized radiating element extends, equals to or is less than 1/20 of a wavelength of the electromagnetic wave.

5. An antenna system as claimed in claim 1, wherein the second direction is perpendicular or substantially perpendicular to the reflector of the antenna system.

6. An antenna system as claimed in claim 1, wherein the coupling feeding line extends, in the first direction, at least from an edge portion of the dielectric substrate to the center portion of the radiating element.

7. An antenna system as claimed in claim 1, further comprising a printed-circuit board arranged on the dielectric substrate, and wherein the dual-polarized radiating element and the coupling feeding line are comprised in the printed-circuit board.

8. An antenna system as claimed in claim 1, wherein:
one or more metallic parts of the dual-polarized radiating element serve as a ground for the coupling feeding line; and
an extension shape of the coupling feeding line in the first direction is at least partially identical to an extension shape of the dual-polarized radiating element in the first direction.

9. (canceled)

10. An antenna system as claimed in claim 1, wherein the coupling feeding line comprises two lines running generally parallel to each other, wherein a first line of the two lines is arranged on the first side of the dielectric substrate, wherein a second line of the two lines is arranged on the second side of the dielectric substrate, and wherein the two lines connect with each other at an end portion of the feeding structure.

11. An antenna system as claimed in claim 1, wherein the feeding structure comprises a first feeding structure and a second feeding structure for providing electrical signals to the dual-polarized radiating element for emission of electromagnetic waves with two different polarizations,
wherein the antenna system further comprises one or more dielectric support structures coupled to the first feeding structure and the second feeding structure to support the first feeding structure and the second feeding structure, and
wherein the first feeding structure and the second feeding structure are spaced apart from each other by a distance equal to or greater than 0.2 times a wavelength of the electromagnetic waves emittable by the dual-polarized radiating element.

12. An antenna system as claimed in claim 1, further comprising a dielectric bridge support structure bridging over at least a portion of the reflector of the antenna system, wherein the antenna system comprises two said dual-polarized radiating elements, and wherein a first one of the dual-polarized radiating elements is arranged on a first end portion of the dielectric bridge support structure, wherein a second one of the dual-polarized radiating elements is arranged on a second end portion of the dielectric bridge support structure and wherein the first end portion of the dielectric bridge support structure is opposite or substantially opposite to the second end portion of the dielectric bridge support structure.

13. An antenna system as claimed in claim 12, further comprising one or more at least partially metallic elements arranged on the dielectric bridge support structure between the first dual-polarized radiating element and the second dual-polarized radiating element, wherein the one or more at least partially metallic elements are electrically isolated from both the first dual-polarized radiating element and the second dual-polarized radiating element.

14. An antenna system as claimed in claim 1, wherein the dual-polarized radiating element comprises a corrugated structure.

15. An antenna system as claimed in claim 1, further comprising one or more stubs or lines arranged on the dielectric substrate, wherein the one or more stubs or lines extend at least in the center portion of the dual-polarized radiating element.

16. An antenna system as claimed in claim 1, wherein a width of the coupling feeding line varies along its length between a coupling of the coupling feeding line to the center portion of the dual-polarized radiating element and a coupling of the coupling feeding line to the feeding structure.

17. An antenna system as claimed in claim 1, wherein the feeding structure is arranged at an edge portion of the dielectric substrate, wherein the dual-polarized radiating element comprises four loops arranged, on the dielectric substrate, generally symmetrically around the center portion of the dual-polarized radiating element, wherein a first loop and a second loop form a first dipole arm of the dual-polarized radiating element, and wherein a third loop and a fourth loop form a second dipole arm of the dual-polarized radiating element.

18. An antenna system as claimed in claim 17,
wherein the first loop is arranged closer to the feeding structure than the second loop, and
wherein the third loop is arranged closer to the feeding structure than the fourth loop.

19. (canceled)

20. An antenna system as claimed in claim 18, wherein the first loop and the third loop are connected to a ground, and wherein the second loop and the fourth loop are connected to a respective coupling feeding line.

21. An antenna system as claimed in claim 17, wherein the first loop and the second loop are electrically coupled to each other via a bridge arranged at the center portion of the dual-polarized radiating element.

22. (canceled)

23. An antenna system as claimed in claim 1, wherein the coupling feeding line comprises a loop structure.

24. An antenna system as claimed in claim 1, further comprising one or more second dual-polarized radiating elements arranged, in relation to a direction perpendicular to the first direction, at least partially between the reflector of the antenna system and the dual-polarized radiating element, wherein the one or more second radiating elements are configured to emit electromagnetic waves having frequencies which are higher than a frequency of the electromagnetic wave emittable by the dual-polarized radiating element.

25. An antenna system as claimed in claim 1, wherein the feeding structure comprises a low-pass filter.
